(19) United States
(12) Patent Application Publication
(10) Pub. No.: US 2022/0334233 A1
(43) Pub. Date: Oct. 20, 2022

(54) DISTANCE MEASUREMENT DEVICE AND CONTROL METHOD OF SAME

(71) Applicant: Hitachi-LG Data Storage, Inc., Tokyo (JP)

(72) Inventor: Takeshi IMAI, Tokyo (JP)

(21) Appl. No.: 17/697,992

(22) Filed: Mar. 18, 2022

(30) Foreign Application Priority Data
Apr. 19, 2021 (JP) 2021-070312

(51) Int. Cl. G01S 7/486; G01S 17/10; G01S 7/481; G01S 7/4865

(52) U.S. Cl. CPC G01S 7/4868; G01S 17/10; G01S 7/4816; G01S 7/4865

(57) ABSTRACT

In a distance measurement device that measures a distance to an object based on a time of flight taken until irradiation light is reflected by the object and returns to the distance measurement device, a brightness measurement unit measures an exposed electric charge amount as a brightness while a shift amount of an exposure gate is changed by an exposure gate shift control unit, and a light emission and exposure timing of another distance measurement device is set to a shift amount of the exposure gate where the brightness is maximized. The brightness measurement unit calculates a variation in the brightness of the exposed electric charge amount while the cycle of the exposure gate is changed, and it is determined that ½ of a value of the cycle of the exposure gate when the variation is minimized is a light emission cycle of the another distance measurement device.

### CROSS-REFERENCE TO RELATED APPLICATION

The present application claims priority from Japanese application JP 2021-070312, filed on Apr. 19, 2021, the contents of which is hereby incorporated by reference into this application.

### BACKGROUND OF THE INVENTION

### 1. Field of the Invention

The present invention relates to a distance measurement device that measures a distance to an object based on a time of flight of light.

### 2. Description of the Related Art

In order to measure a distance to an object and to obtain a distance image, a distance measurement imaging device (hereinafter, distance measurement device) using a method for measuring a distance based on a time of flight taken until irradiation light is reflected by the object and returns to the device (Time of Flight: TOF) has been put to practical use. In the distance measurement device, in order to measure a distance, the emission of irradiation light and exposure to reflected light are periodically repeated, and a time delay of the reflected light of the irradiation light is calculated from the amount of exposure accumulated in a predetermined exposure period, to obtain the distance. At this time, when a plurality of distance measurement devices having the same light emission cycle exist in a measurement range, interference occurs which causes the amounts of light to intensify each other, and accurate distance measurement cannot be performed. In this case, the light emission cycle for each distance measurement device needs to be changed to prevent interference.

JP 2021-60246 A discloses a background technique of the technical field. As means for confirming whether or not interference occurs, JP 2021-60246 A discloses a method in which a variation in distance is measured for each of all combinations of light emission periods and light emission cycles and a combination causing a maximum variation is detected.

In JP 2021-60246 A, measurement needs to be performed for all the combinations of light emission periods and light emission cycles, thereby consuming time, which is a problem.

### SUMMARY OF THE INVENTION

In view of the above problem, an object of the present invention is to provide a distance measurement device and a control method of the same that are capable of shortening the time taken to detect an interfering light emission cycle.

According to one aspect of the present invention, there is provided a distance measurement device that measures a distance to an object based on a time of flight taken until irradiation light is reflected by the object and returns to the distance measurement device. A brightness measurement unit measures an exposed electric charge amount as a brightness while a shift amount of an exposure gate is changed by an exposure gate shift control unit, and a light emission and exposure timing of another distance measurement device is set to a shift amount of the exposure gate where the brightness is maximized. The brightness measurement unit calculates a variation in the brightness of the exposed electric charge amount while a cycle of the exposure gate is changed by an exposure gate cycle control unit, and it is determined that a value of the cycle of the exposure gate is a light emission period of the another distance measurement device, depending on whether or not there is a variation. The brightness measurement unit calculates a variation in the brightness of the exposed electric charge amount while the cycle of the exposure gate is changed by the exposure gate cycle control unit, and it is determined that ½ of a value of the cycle of the exposure gate when the variation is minimized is a light emission cycle of the another distance measurement device.

According to the present invention, it is possible to provide a distance measurement device and a control method of the same that are capable of shortening the time taken to detect an interfering light emission cycle.

### BRIEF DESCRIPTION OF THE DRAWINGS

FIG. 1 is a functional block diagram of a distance measurement device in a first embodiment;

FIG. 2 is a view describing the principle of distance measurement;

FIG. 3 is a view describing an influence of interference on distance measurement;

FIG. 4 is a view describing a condition where interference occurs between distance measurement devices in the first embodiment;

FIG. 5 is a view showing an example of a time chart of distance measurement by the distance measurement device in the first embodiment;

FIG. 6 is a flowchart of an overall process for measuring light emitted from another distance measurement device in the first embodiment;

FIG. 7 is a view showing a relationship between a light emission period To and a measurement distance range of the distance measurement device when the measurement distance range is short in the first embodiment;

FIG. 8 is a view showing a relationship between the light emission period To and a measurement distance range of the distance measurement device when the measurement distance range is long in the first embodiment;

FIG. 9 is a setting table of light emission periods of the distance measurement device and of light emission cycles corresponding to the light emission periods in the first embodiment;

FIG. 10 is a view describing an exposure period of the measurement device corresponding to a light emission and exposure period of a measurement device under investigation in the first embodiment;

FIG. 11 is a flowchart for detecting a light emission and exposure timing of the measurement device under investigation in the first embodiment;

FIG. 12 is a view showing a relationship between the amount of exposure and an exposure gate cycle Te of the measurement device in the case of the exposure gate cycle Te=the light emission period To of the measurement device under investigation in the first embodiment;

FIG. 13 is a view showing a relationship between the amount of exposure and the exposure gate cycle Te of the measurement device in the case of the exposure gate cycle Te=2×the light emission period To of the measurement device under investigation in the first embodiment;

FIG. 14 is a table showing where or not there is a variation in the amount of exposure according to a relationship between the exposure gate cycle Te of the measurement device and the light emission period To of the measurement device under investigation in the first embodiment;

FIG. 15 is a flowchart for detecting the light emission period To of the measurement device under investigation in the first embodiment;

FIG. 16 is a view showing a relationship between the exposure gate cycle Te of the measurement device and the amount of exposure and a light emission cycle Ti of the measurement device under investigation in the case of the exposure gate cycle Te=2×the light emission cycle Ti in the first embodiment;

FIG. 17 is a view showing a relationship between the amount of exposure and the exposure gate cycle Te of the measurement device in the case of the exposure gate cycle Te>2×the light emission cycle Ti of the measurement device under investigation in the first embodiment;

FIG. 18 is a view showing a relationship between the amount of exposure and the exposure gate cycle Te of the measurement device in the case of the exposure gate cycle Te<2×the light emission cycle Ti of the measurement device under investigation in the first embodiment;

FIG. 19 is a table showing a relationship of a variation in the amount of exposure when the exposure gate cycle Te of the measurement device is set to a value twice the light emission cycle Ti that is paired with the identified light emission period To of the measurement device under investigation in the first embodiment;

FIG. 20 is another table showing a relationship of a variation in the amount of exposure when the exposure gate cycle Te of the measurement device is set to a value twice the light emission cycle Ti that is paired with the identified light emission period To of the measurement device under investigation in the first embodiment;

FIG. 21 is another table showing a relationship of a variation in the amount of exposure when the exposure gate cycle Te of the measurement device is set to a value twice the light emission cycle Ti that is paired with the identified light emission period To of the measurement device under investigation in the first embodiment;

FIG. 22 is another table showing a relationship of a variation in the amount of exposure when the exposure gate cycle Te of the measurement device is set to a value twice the light emission cycle Ti that is paired with the identified light emission period To of the measurement device under investigation in the first embodiment;

FIG. 23 is a flowchart for detecting the light emission cycle Ti of the measurement device under investigation in the first embodiment;

FIG. 24 is a graph showing a variation in the amount of exposure when the exposure gate cycle Te of the measurement device is changed in a second embodiment;

FIG. 25 is a table showing the exposure gate cycle Te in which the variation in the amount of exposure decreases and the interval of the exposure gate cycle Te in the second embodiment;

FIG. 26 is a flowchart for detecting the light emission period To and the light emission cycle Ti of the measurement device under investigation that is not an in-house product in the second embodiment; and

FIG. 27 shows a detailed flowchart of a process for determining the light emission period To and the light emission cycle Ti of the measurement device under investigation in the second embodiment.

### DETAILED DESCRIPTION OF THE PREFERRED EMBODIMENTS

Hereinafter, embodiments of the present invention will be described with reference to the drawings.

### First Embodiment

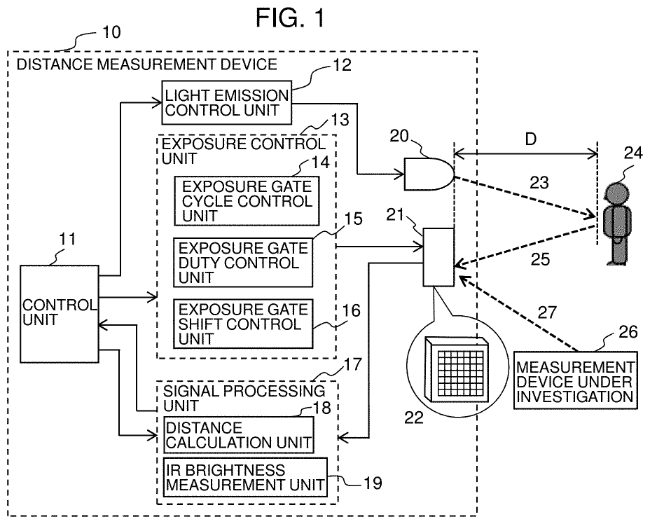

FIG. 1 is a functional block diagram of a distance measurement device in the present embodiment. In FIG. 1, when a distance measurement device 10 measures a distance to an object 24, irradiation light 23 such as laser from a light-emitting unit 20 driven in a pulse pattern is reflected by the object 24, and an image sensor 22 such as a CCD sensor in a light-receiving unit 21 is exposed to reflected light 25 of the irradiation light 23, and converts the reflected light 25 into an electric signal, pixels being two-dimensionally disposed in the image sensor 22. A distance calculation unit 18 of a signal processing unit 17 calculates a distance D from an output signal from the light-receiving unit 21.

A light emission control unit 12 controls the emission of the irradiation light 23 from the light-emitting unit 20. An exposure control unit 13 controls an exposure gate cycle for the reflected light 25 in the light-receiving unit 21 (hereinafter, also referred to as an exposure cycle). A control unit 11 has a light emission and exposure set value table, and selects a light emission cycle value, an emission duty value, an exposure cycle value, and an exposure duty value in the arbitrary table according to a user's instruction. The selected light emission and exposure set values are set in the light emission control unit 12 and in the exposure control unit 13 by the control unit 11.

Then, when another distance measurement device (measurement device under investigation) 26 exists in a distance measurement range of the distance measurement device 10, illumination light from the another distance measurement device 26 or reflected light of the illumination light may be incident on the light-receiving unit 21 of the distance measurement device 10, as interference light 27. The interference light 27 affects the distance D calculated by the distance calculation unit 18.

Therefore, the light emission cycle needs to be changed for each distance measurement device to prevent interference, so that light emitted from the another distance measurement device 26 is measured for that purpose.

When light emitted from the another distance measurement device (measurement device under investigation) 26 is measured, although the details will be described later, the control unit 11 instructs the light emission control unit 12 to cause the light-emitting unit 20 to stop laser irradiation. In addition, the control unit 11 instructs an exposure gate cycle control unit 14 of the exposure control unit 13 of a cycle of an exposure gate, and instructs an exposure gate duty control unit 15 of a duty of 50%, and the interference light 27 of the measurement device 26 under investigation is measured. In addition, the control unit 11 instructs an exposure gate shift control unit 16 to perform the time shift of the exposure gate. An IR brightness measurement unit 19 of the signal processing unit 17 detects an output signal from the light-receiving unit 21 as an infrared (IR) brightness. The control unit 11 detects a variation in IR brightness caused by the time shift of the exposure gate.

Incidentally, a hardware image of the distance measurement device 10 excluding the light-emitting unit 20 and the light-receiving unit 21 includes a processing processor such as a general central processing unit (CPU) and a storage device, and functions of the control unit 11, the light emission control unit 12, the exposure control unit 13, and the signal processing unit 17 shown in FIG. 1 are executed by reading programs and information for realizing the functions from the storage device and by performing predetermined processing in the form of software processing.

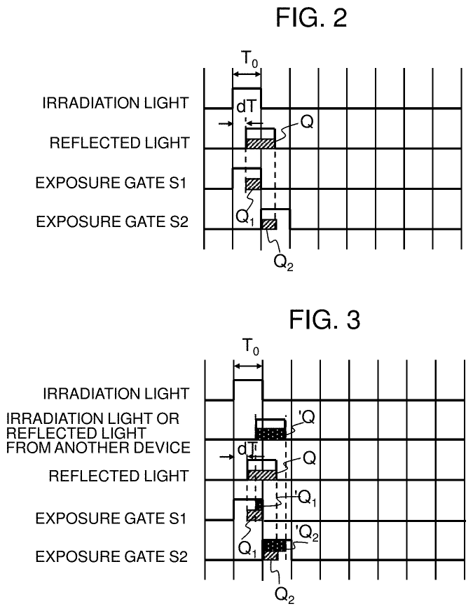

FIG. 2 is a view describing the principle of distance measurement. In the distance measurement, as shown in FIG. 2, the distance D to the object 24 can be calculated by D=dT×c/2 based on a time difference dT between the irradiation light 23 and the reflected light 25, where c is the speed of light. In addition, as shown in FIG. 2, when an exposure operation for one irradiation light (pulse width T₀) is divided into, for example, two gates and is performed, the time difference dT can be obtained based on electric charge amounts Q₁ and Q₂ accumulated in the image sensor by exposure gates S1 and S2, and a ratio of the irradiation light to the pulse width T₀, and dT=T₀×Q₂/(Q₁+Q₂). From the above equations, the distance D can be calculated as D=T₀×Q₂/(Q₁+Q₂)×c/2.

FIG. 3 is a view describing an influence of interference on distance measurement. In FIG. 3, when the distance measurement device 10 is exposed to irradiation light or reflected light that is the interference light 27 from another distance measurement device 26 (another device), an error occurs in the value of the distance D. Namely, the interference light from the another device causes the electric charge amounts accumulated in the image sensor at the exposure gates S1 and S2, to be Q₁+′Q₁ and Q₂+′Q₂, respectively.

For this reason, a distance D′ is calculated as D′=T₀×(Q₂+′Q₂)/(Q₁+′Q₁+Q₂+′Q₂)×c/2, and is shifted from the distance D.

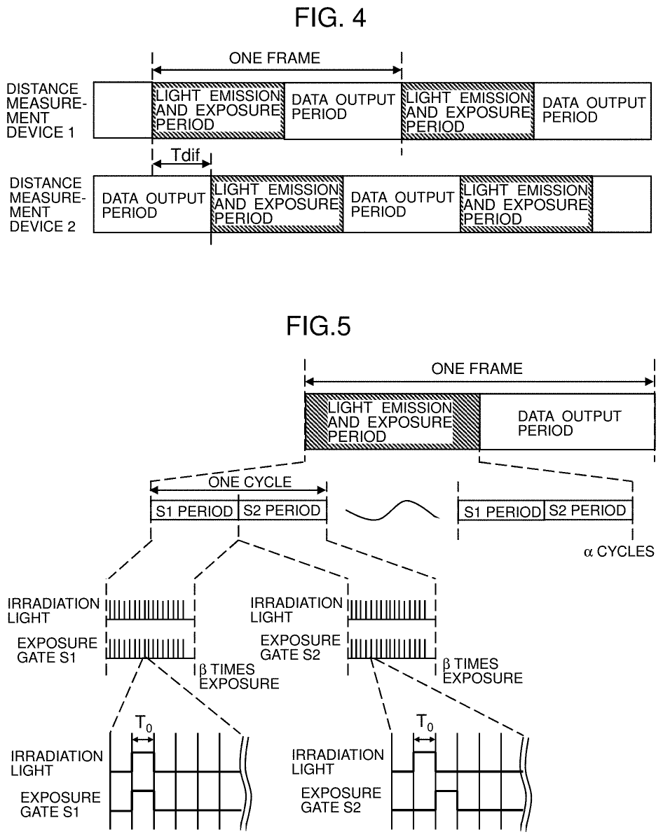

FIG. 4 is a view describing a condition where interference occurs between distance measurement devices in the present embodiment. FIG. 4 shows the timings of light emission and exposure operations of two distance measurement devices 1 and 2. The distance measurement device alternately executes a light emission and exposure operation in which the irradiation light 23 is emitted to the object 24 and the distance measurement device is exposed to the reflected light 25 of the irradiation light 23, and a data output operation in which an exposed electric charge in the image sensor 22 is output to the signal processing unit 17. A light emission and exposure period that is a period of the light emission and exposure operation and a data output period that is a period of the data output operation are defined as one frame.

When the another distance measurement device 2 exists in a measurement range of the distance measurement device 1 and has the same light emission and exposure cycle as that of the distance measurement device 1, interference occurs, and the influence of the interference is also dependent on a time difference Tdif in frame between the distance measurement device 1 and the distance measurement device 2. Namely, when Tdif is small, the light emission and exposure cycles of the distance measurement devices 1 and 2 are the same, and the light emission and exposure period overlap each other, the influence of the interference increases, and when Tdif is large and there is a small overlap between the light emission and exposure periods, the influence of the interference decreases.

In addition, since a reference clock of each distance measurement device has an error, a slight difference is generated in the time of one frame of each distance measurement device. For this reason, the time difference Tdif is not constant, so that the overlap of the light emission and exposure periods changes periodically.

FIG. 5 is a view showing an example of a time chart of distance measurement by the distance measurement device in the present embodiment. In FIG. 5, light emission and the exposure gate S1 are repeated β times in an S1 period, light emission and the exposure gate S2 are repeated β times in an S2 period, a combination of the S1 period and the S2 period is one cycle, and in the light emission and exposure period, the cycle is repeated for α cycles.

The β-time repetition cycle is the light emission and exposure cycle, and when another distance measurement device has the same cycle and Tdif is small, interference occurs.

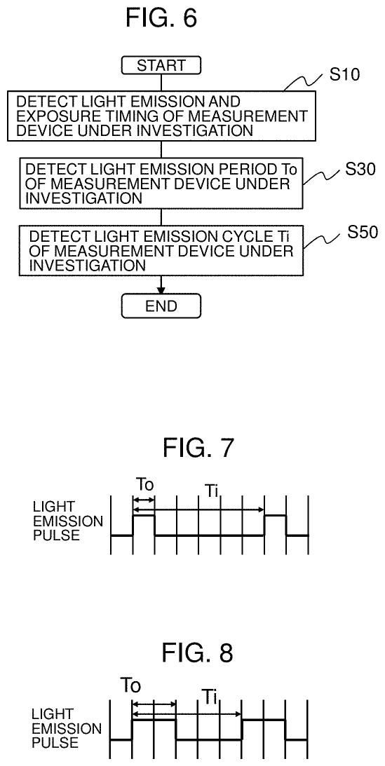

FIG. 6 is a flowchart of an overall process for measuring light emitted from another distance measurement device in the present embodiment. In FIG. 6, first, in step S10, in order that a host distance measurement device (hereinafter, measurement device) receives light emitted from another distance measurement device (hereinafter, measurement device under investigation) of which the light emission is to be measured, a light emission and exposure timing of the measurement device under investigation is detected.

Next, in step S30, the light emission period To of a light emission pulse of the measurement device under investigation within the detected light emission and exposure period is detected. The light emission period To is a time corresponding to a measurement distance range of the distance measurement device.

FIGS. 7 and 8 are views showing a relationship between the light emission period To and the measurement distance range of the distance measurement device in the present embodiment, FIG. 7 shows a case where the measurement distance range is short, and FIG. 8 shows a case where the measurement distance range is long. As shown in FIGS. 7 and 8, the longer the light emission period To is, the longer the measurable distance range of the distance measurement device is.

Subsequently, in step S50 of FIG. 6, the light emission cycle Ti used for the detected light emission period To is detected. The light emission cycle Ti is the above-described repetition cycle of light emission and the exposure gate. In order to prevent interference, the light emission cycles Ti needs to be set to different values between the distance measurement devices.

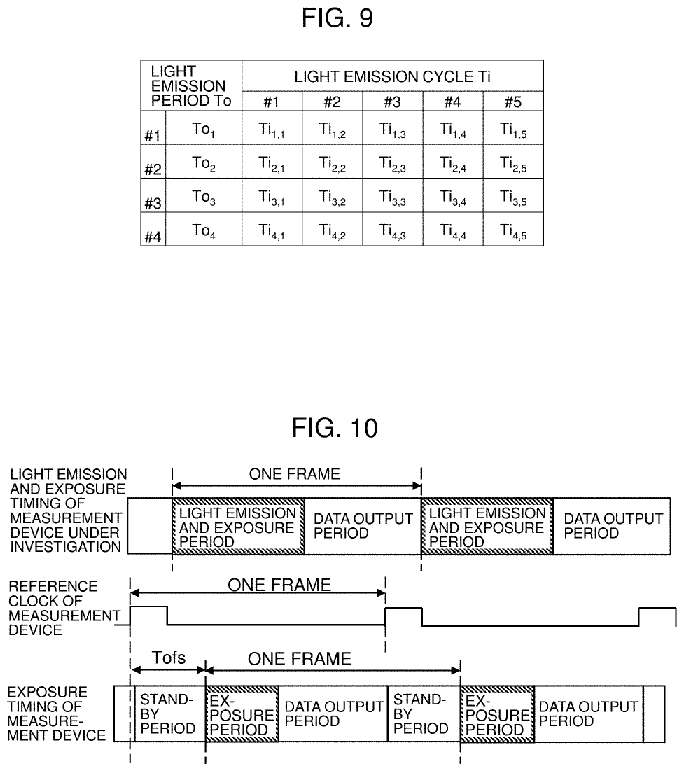

FIG. 9 is a setting table of light emission periods of the distance measurement device and of light emission cycles corresponding to the light emission periods in the present embodiment. In the present embodiment, as shown in FIG. 9, there are four light emission periods To such as To₁, To₂, To₃, and To₄, and the light emission cycles Ti corresponding thereto are combinations of Ti_{1,1} to Ti_{1,5}, Ti_{2,1} to Ti_{2,5}, Ti_{3,1} to Ti_{3,5}, and Ti_{4,1} to Ti_{4,5}. The light emission period To is determined by the distance measurement range, and a value of the light emission cycle Ti which does not overlap that of the another distance measurement device needs to be selected to prevent interference with the another distance measurement device. The selected value is set in the light emission control unit 12 and in the exposure control unit 13 by the control unit 11. The light emission control unit 12 causes the light-emitting unit 20 to emit light according to the value.

The exposure control unit 13 causes the light-receiving unit 21 to be exposed to light according to the value. Since a value that can be taken for the light emission cycle Ti is determined by the light emission period To, the light emission period To is detected first.

Next, the detection of the light emission and exposure timing of the measurement device under investigation in step S10 of FIG. 6 will be described in detail.

FIG. 10 is a view describing an exposure period of the measurement device corresponding to a light emission and exposure period of the measurement device under investigation in the present embodiment.

In order to detect light emitted from the measurement device under investigation, the exposure period of the measurement device needs to be included in the light emission and exposure period of the measurement device under investigation. In the measurement device under investigation, there are a light emission and exposure period and a data output period in one frame. The light emission and exposure period of the measurement device under investigation is unknown to the measurement device. For this reason, for example, when the exposure period of the measurement device overlaps the data output period of the measurement device under investigation, the measurement device cannot receive irradiation light from the measurement device under investigation.

The measurement device has an exposure period, a data output period, and a standby period in one frame. In addition, the exposure period of the measurement device is set to a period shorter than the light emission and exposure period of the measurement device under investigation. For this reason, in the present embodiment, the measurement device starts being exposed to light at a timing that is shifted by a time offset Tofs with respect to its own reference clock, and as one example, the measurement device measures infrared (IR) brightnesses while continuing to shift Tofs from 0 ms by 1 ms. Then, the IR brightnesses are measured until Tofs reaches 32 ms (value obtained by subtracting 1 ms from 33 ms that is a period of one frame), and Tofs where the brightness is maximized is obtained. In such a manner, the measurement device starts being exposed to light from a timing that is shifted from the reference clock by Tofs where the brightness maximized, so that the measurement device can certainly receive irradiation light from the measurement device under investigation. Incidentally, it can be said that the detection of the light emission and exposure timing of the measurement device under investigation is to detect the light emission and exposure period of the measurement device under investigation.

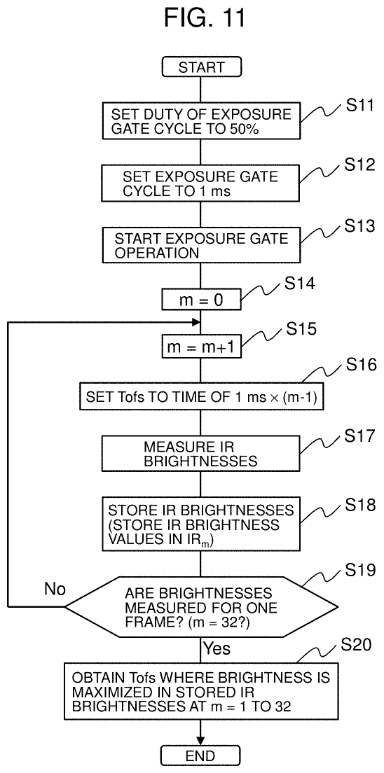

FIG. 11 is a flowchart for detecting the light emission and exposure timing of the measurement device under investigation in the present embodiment. In FIG. 11, first, in step S11, the exposure gate duty control unit 15 of the exposure control unit 13 sets the duty of the exposure gate cycle of the measurement device to 50%, and in step S12, the exposure gate cycle control unit 14 sets the exposure gate cycle to 1 ms. Then, in step S13, an exposure operation by the exposure gate is started.

Then, in steps S14 to S19, the exposure gate shift control unit 16 changes the time offset Tofs from the reference clock from 0 ms to 32 ms to shift the timing of IR brightness measurement, and in IR brightness measurement, the IR brightness measurement unit 19 repeatedly performs light exposure for ¼ frame to measure a total exposed electric charge amount as an IR brightness.

Then, in step S20, after measurement is performed until the time offset reaches 32 ms, the control unit 11 obtains the time offset Tofs where the IR brightness is maximized, and sets the obtained time offset Tofs as an exposure start timing for the subsequent measurements.

Next, the detection of the light emission period To of the measurement device under investigation in step S30 of FIG. 6 will be described in detail.

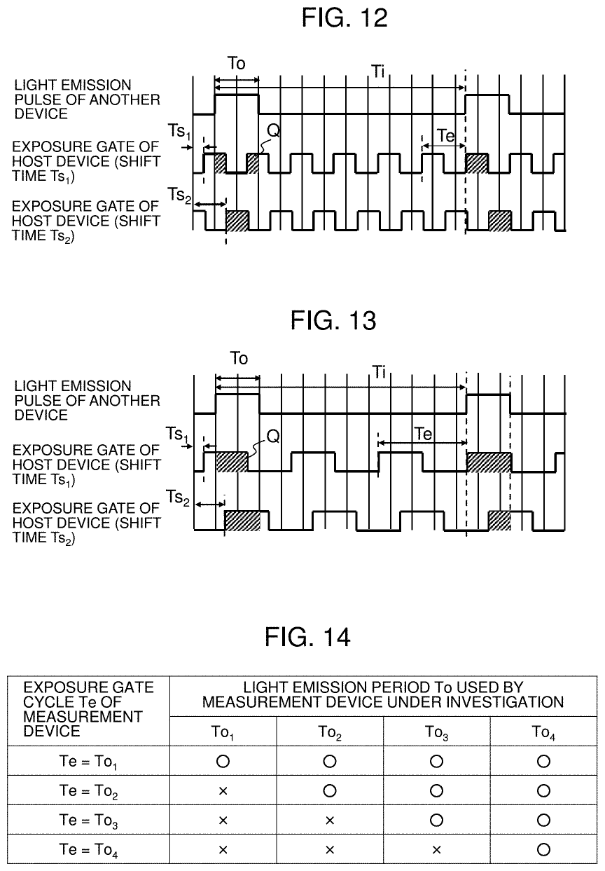

FIGS. 12 and 13 are views showing a relationship between the exposure gate cycle Te and the amount of exposure of the measurement device and the light emission period To of the measurement device under investigation in the present embodiment, FIG. 12 shows the case of the exposure gate cycle Te=the light emission period To, and FIG. 13 shows the case of the exposure gate cycle Te=the light emission period To×2.

As shown in FIG. 12, in a case where the exposure gate duty of the measurement device is set to 50% and the exposure gate cycle Te is set to a divisor (the same in the drawing) of the light emission period To of the measurement device under investigation, even when there is a phase shift (shift Ts₁ or Ts₂ of a shift time Ts of the exposure gate), the total amount of exposure does not change. For example, in a case where the light emission period To of the measurement device under investigation is 10 ns, even when the exposure gate cycle Te of the measurement device is set to any one of 1 ns, 2 ns, 5 ns, and 10 ns that are divisors of 10 ns, the total amount of exposure does not change.

On the other hand, as shown in FIG. 13, when the exposure gate cycle Te of the measurement device is set to be longer than the light emission period To of the measurement device under investigation (twice in the drawing), a variation in the amount of exposure which is dependent on the phase shift is generated. Namely, when there is no variation in the amount of exposure, the exposure gate cycle Te of the measurement device coincides with the light emission period To of the measurement device under investigation. When there is a variation in the amount of exposure, the exposure gate cycle Te of the measurement device does not coincide with the light emission period To of the measurement device under investigation. Therefore, the light emission period To of the measurement device under investigation can be detected by detecting a difference in the variation.

FIG. 14 is a table showing where or not there is a variation in the amount of exposure according to a relationship between the exposure gate cycle Te of the measurement device and the light emission period To of the measurement device under investigation in the present embodiment. FIG. 14 shows a relationship of a variation in the amount of exposure when the exposure gate cycle Te of the measurement device is set to the same value as each of To₁, To₂, To₃, and To₄ in a case where the measurement device under investigation is, for example, an in-house product and it is known that any one of four values of To₁, To₂, To₃, and To₄ is used as a set value of the light emission period To of the measurement device under investigation. Incidentally, ◯ indicates that there is no variation, × indicates that there is a variation, and the light emission periods have a magnitude relationship of To₁<To₂<To₃<To₄.

In FIG. 14, the measurement device tries To₂, To₃, and To₄ in order from To′ for the exposure gate cycle Te, ends the measurement when there is determined to be a variation, and can determine that a value of the exposure gate cycle Te immediately before the end of the measurement is the light emission period To of the measurement device under investigation. In addition, when it cannot be determined that there is a variation, it can be determined that a final value of the exposure gate cycle Te is the light emission period To of the measurement device under investigation.

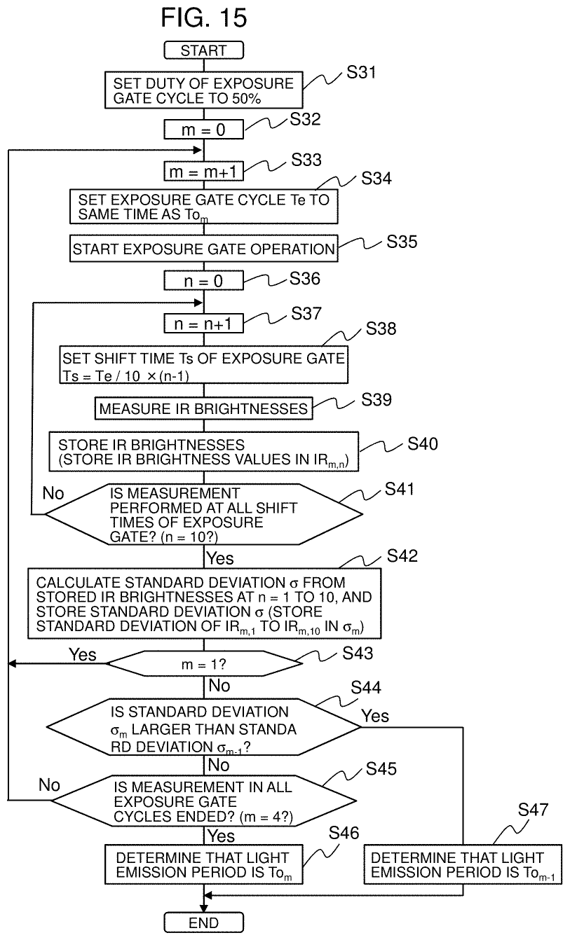

FIG. 15 is a flowchart for detecting the light emission period To of the measurement device under investigation in the present embodiment. FIG. 15 describes an operation under the conditions of FIG. 14. In FIG. 15, first, in step S31, the exposure gate duty control unit 15 sets the duty of the exposure gate cycle of the measurement device to 50%. Then, in steps S32 to S34, an initial setting is made and the exposure gate cycle control unit 14 sets the exposure gate cycle Te to To₁, and in step S35, an exposure operation by the exposure gate is started.

Then, in steps S36 to S45, To₁ to To₄ that is a maximum value are tried for the exposure gate cycle Te. In addition, the measurement device uses the time that is shifted from the reference clock by the time offset Tofs obtained above, as an exposure start reference time. The exposure gate shift control unit 16 shifts an actual exposure start timing with respect to the exposure start reference time by the shift time Ts of the exposure gate. In the present embodiment, as shown in step S38, the shift time Ts is set to 1/10 of the exposure gate cycle. In IR brightness measurement of step S39, light exposure is repeatedly performed for ¼ frame, and the IR brightness measurement unit 19 measures the total exposed electric charge amount as an IR brightness. In step S42, the control unit 11 calculates a standard deviation as an index of a variation in IR brightness, and in step S44, compares the calculated standard deviation with a standard deviation in the previous exposure gate cycle. When the current standard deviation is larger than the previous standard deviation by a reference, the measurement is ended, and in step S47, it is determined that the previous exposure gate cycle is the light emission period To of the measurement device under investigation. Incidentally, a comparison value to be compared with a ratio between the previous and current standard deviations of IR brightnesses is defined as k. As for the value of k, an appropriate value is obtained in advance by trial and error in actual experiments.

In step S45, in the case of To₄ where the exposure gate cycle Te is maximized, in step S46, it is determined that To₄ (Toₘ) that is a final value of the exposure gate cycle Te is the light emission period To of the measurement device under investigation.

Next, the detection of the light emission cycle Ti of the measurement device under investigation in step S50 of FIG. 6 will be described in detail.

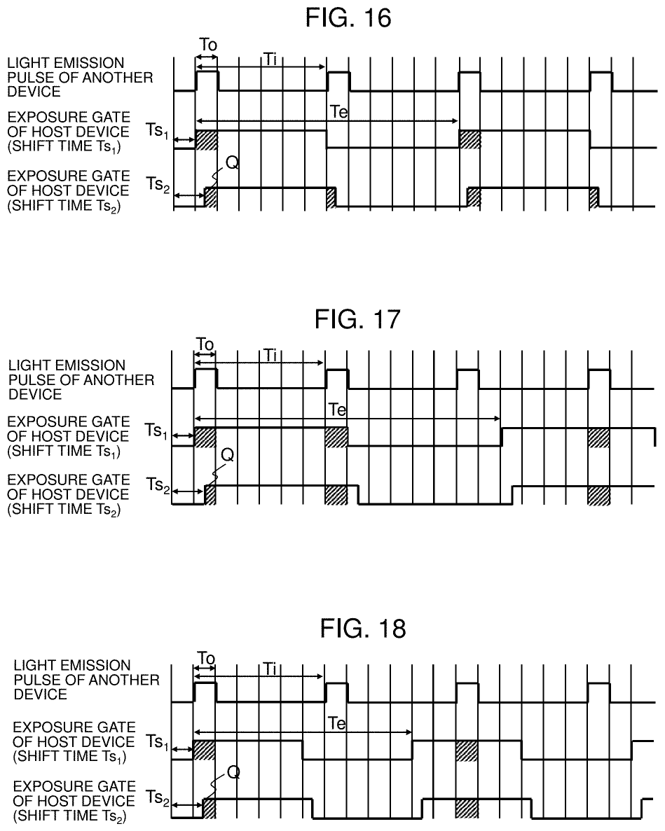

FIGS. 16, 17, and 18 are views showing a relationship between the exposure gate cycle Te and the amount of exposure of the measurement device and the light emission cycle Ti of the measurement device under investigation in the present embodiment, FIG. 16 shows the case of the exposure gate cycle Te=the light emission cycle Ti×2, FIG. 17 shows the case of the exposure gate cycle Te>the light emission cycle Ti×2, and FIG. 18 shows the case of the exposure gate cycle Te<the light emission cycle Ti×2.

As shown in FIG. 16, in a case where the exposure gate duty of the measurement device is set to 50% and the exposure gate cycle Te is set to twice the light emission cycle Ti of the measurement device under investigation, even when there is a phase shift (shift time Ts of the exposure gate), the total amount of exposure does not change. On the other hand, as shown in FIGS. 17 and 18, when the exposure gate cycle Te of the measurement device is set to be longer or shorter than twice the light emission cycle Ti of the measurement device under investigation, a variation in the amount of exposure which is dependent on the phase shift is generated. Namely, when there is no variation in the amount of exposure, ½ value of the exposure gate cycle Te of the measurement device coincides with the light emission cycle Ti of the measurement device under investigation. When there is a variation in the amount of exposure, ½ value of the exposure gate cycle Te of the measurement device does not coincide with the light emission cycle Ti of the measurement device under investigation. Therefore, the light emission cycle Ti of the measurement device under investigation can be detected by detecting a difference in the variation.

The distance measurement device prepares a plurality of the setting tables of the light emission period To and of the light emission cycle Ti corresponding to the light emission period To shown in FIG. 9 to avoid interference. Since the light emission period To of the measurement device under investigation is identified to the measurement device as described above, the light emission cycle Ti that is paired with the light emission period To may be investigated.

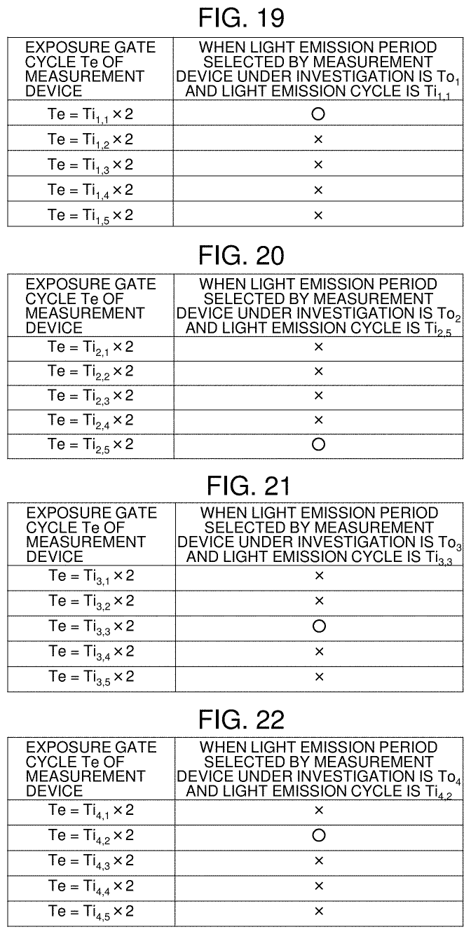

FIGS. 19 to 22 show a relationship of a variation in the amount of exposure when the exposure gate cycle Te of the measurement device is set to a value twice the light emission cycle Ti that is paired with the identified light emission period To of the measurement device under investigation in the present embodiment. Incidentally, ◯ indicates that there is no variation, and × indicates that there is a variation.

FIG. 19 shows a case where the measurement device under investigation uses the light emission period To₁ and the light emission cycle Ti_{1,1}.

FIG. 20 shows a case where the measurement device under investigation uses the light emission period Toe and the light emission cycle Ti_{2,5}.

FIG. 21 shows a case where the measurement device under investigation uses the light emission period Toa and the light emission cycle Ti_{3,3}.

FIG. 22 shows a case where the measurement device under investigation uses the light emission period To₄ and the light emission cycle Ti_{4,2}.

From this relationship, it can be determined that ½ value of the exposure gate cycle Te of the measurement device when there is determined to be no variation in light exposure is the light emission cycle Ti of the measurement device under investigation.

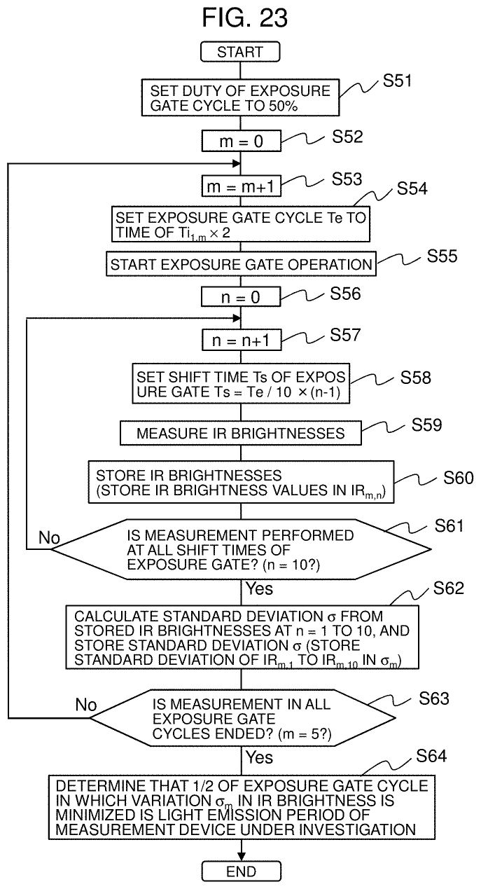

FIG. 23 is a flowchart for detecting the light emission cycle Ti of the measurement device under investigation in the present embodiment. In FIG. 23, the light emission period To of the measurement device under investigation is already determined and is set to To₁. First, in step S51, the exposure gate duty control unit 15 sets the duty of the exposure gate cycle of the measurement device to 50%. Then, in steps S52 to S54, an initial setting is made and the exposure gate cycle control unit 14 sets the exposure gate cycle Te to Ti_{1,1}×2, and in step S55, an exposure operation by the exposure gate is started. Then, in steps S56 to S63, Ti_{1,1}×2 to Ti_{1,5}×2 are tried for the exposure gate cycle Te.

In addition, the measurement device uses the time that is shifted from the reference clock by the time offset Tofs obtained above, as an exposure start reference time.

The exposure gate shift control unit 16 shifts an actual exposure start timing with respect to the exposure start reference time by the shift time Ts of the exposure gate.

In the present embodiment, as shown in step S58, the shift time Ts is set to 1/10 of the exposure gate cycle. In IR brightness measurement of step S59, light exposure is repeatedly performed for ¼ frame, and the IR brightness measurement unit 19 measures the total exposed electric charge amount as an IR brightness. In step S62, the control unit 11 calculates a standard deviation as an index of a variation in IR brightness.

In step S64, after values are tried up to Ti_{1,5}=2 for the exposure gate cycle Te, the magnitudes of standard deviations of IR brightnesses are compared with each other, and it is determined that ½ of the exposure gate cycle Te when the magnitude is at its minimum is the light emission cycle Ti of the measurement device under investigation.

As described above, according to the present embodiment, it is possible to provide the distance measurement device and a control method of the same that are capable of shortening the time taken to measure an interfering light emission cycle, reducing the working time when the distance measurement device is installed, and detecting interference after the installation.

### Second Embodiment

When the measurement device under investigation is not an in-house product, the light emission period To and the light emission cycle Ti are unknown, and combinations thereof are unknown. In the present embodiment, a technique for detecting the light emission period and the light emission cycle even in this case will be described.

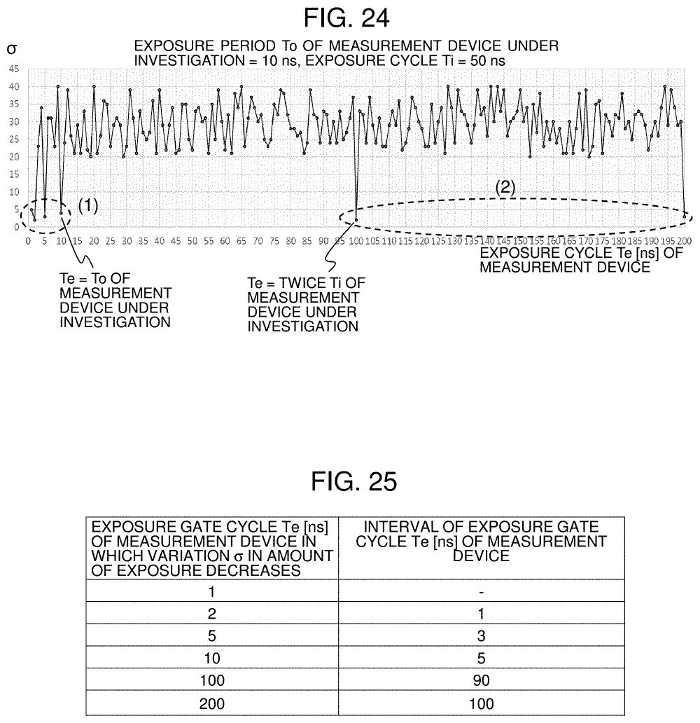

FIG. 24 is a graph showing a variation in the amount of exposure when the exposure gate cycle Te of the measurement device is changed in the present embodiment. FIG. 24 shows a variation in the amount of exposure when the exposure gate duty of the measurement device is set to 50% and the exposure gate cycle Te is changed from 1 ns to 200 ns. In addition, each time the exposure gate cycle Te is changed, the measurement device also changes the shift time Ts described above, to generate a variation in light exposure. In addition, the light emission period To of the measurement device under investigation is 10 ns, and the light emission cycle Ti is 50 ns.

In FIG. 24, as described with reference to FIG. 12, when the exposure gate cycle Te of the measurement device is 1 ns, 2 ns, 5 ns, and 10 ns which are divisors of 10 ns that is a value of the light emission period To of the measurement device under investigation as indicated by a broken line circle (1), the variation in the amount of exposure decreases. In addition, as described with reference to FIG. 16, when the exposure gate cycle Te of the measurement device is 100 ns and 200 ns which are even multiples of 50 ns that is a value of the light emission cycle Ti of the measurement device under investigation as indicated by a broken line circle (2), the variation in the amount of exposure decreases. Therefore, a maximum value of the exposure gate cycle Te in the broken line circle (1) coincides with the light emission period To of the measurement device under investigation. In addition, a minimum value in the broken line circle (2) coincides with a value twice the light emission cycle Ti of the measurement device under investigation.

FIG. 25 is a table showing a plurality of the exposure gate cycles Te in which the variation in the amount of exposure decreases and an interval between the exposure gate cycle Te in which the variation decreases and the exposure gate cycle Te immediately before when the exposure gate cycle Te is changed from 1 ns to 200 ns in the present embodiment. For example, when a threshold value of the interval of the exposure gate cycle is set to 50 ns that is ½ value of a maximum interval value of 100 ns, a value of 10 ns where the interval is the threshold value or less and the exposure gate cycle is maximized is the light emission period To of the measurement device under investigation, and a value of 100 ns where the interval is the threshold value or more and the exposure gate cycle is minimized is a value twice the light emission cycle Ti, so that the light emission cycle Ti of the measurement device under investigation can be determined to be 50 ns.

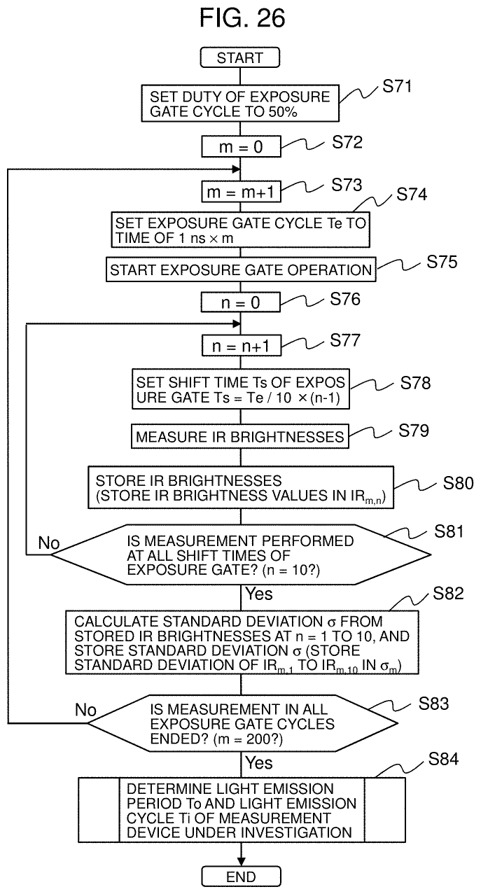

FIG. 26 is a flowchart for detecting the light emission period To and the light emission cycle Ti of the measurement device under investigation that is not an in-house product in the present embodiment. In FIG. 26, first, in step S71, the duty of the exposure gate cycle of the measurement device is set to 50%. Then, in steps S72 to S74, an initial setting is made and in step S75, an exposure operation by the exposure gate is started. Then, in steps S76 to S83, 1 ns to 200 ns are tried for the exposure gate cycle of the measurement device.

In addition, the measurement device uses the time that is shifted from the reference clock by the time offset Tofs obtained above, as an exposure start reference time.

An actual exposure start timing is shifted with respect to the exposure start reference time by the shift time Ts of the exposure gate.

In the present embodiment, as shown in step S78, the shift time Ts is set to 1/10 of the exposure gate cycle. In IR brightness measurement of step S79, light exposure is repeatedly performed for ¼ frame, and the total exposed electric charge amount is measured as an IR brightness. In step S82, a standard deviation is calculated as an index of a variation in IR brightness.

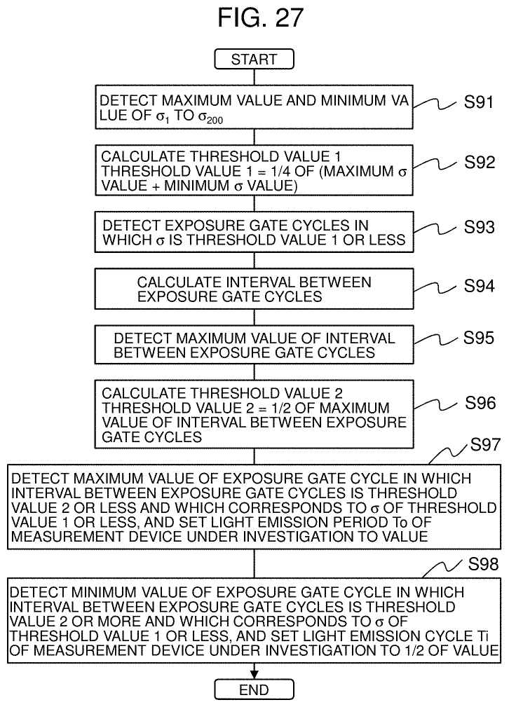

In step S84, after values are tried up to 200 ns for the exposure gate cycle Te, the light emission period To and the light emission cycle Ti of the measurement device under investigation are determined. FIG. 27 shows a detailed flowchart of a process for determining the light emission period To and the light emission cycle Ti of the measurement device under investigation shown in step S84.

In FIG. 27, first, in step S91, a maximum value and a minimum value of standard deviations σ₁ to σ₂₀₀ of IR brightnesses are detected. Then, in step S92, a threshold value 1 is set to one fourth value of the maximum value and the minimum value. Incidentally, in the present embodiment, the threshold value 1 is set to the one fourth value, but an optimal value is obtained by trial and error according to an actual situation. Then, in step S93, exposure gate cycles in which the standard deviation is the threshold value 1 or less are detected, and in step S94, an interval between the exposure gate cycles is detected. Then, in step S95, a maximum value of the interval is detected, and in step S96, a threshold value 2 is set to ½ value thereof. Incidentally, in the present embodiment, the threshold value 2 is set to the ½ value, but an optimal value is obtained by trial and error according to an actual situation.

Then, in step S97, a maximum value of the exposure gate cycle in which the interval of the exposure gate cycle is the threshold value 2 or less and which corresponds to a standard deviation equal to or less than the threshold value 1, and the light emission period To of the measurement device under investigation is set to the value. In addition, in step S98, a minimum value of the exposure gate cycle in which the interval of the exposure gate cycle is the threshold value 2 or more and which corresponds to a standard deviation equal to or less than the threshold value 1, and the light emission cycle Ti of the measurement device under investigation is set to ½ of the value.

As described above, according to the present embodiment, when the measurement device under investigation is not an in-house product, the light emission period and the light emission cycle are unknown, but even in this case, it is possible to detect the light emission period and the light emission cycle.

The embodiments have been described above; however, the present invention is not limited to the above embodiments and includes various modification examples. For example, the above embodiments have been described in detail to facilitate understanding of the present invention, and the present invention is not necessarily limited to including all the described configurations. In addition, a part of the configuration of an embodiment can be replaced with the configuration of another embodiment, and the configuration of another embodiment can be added to the configuration of an embodiment. In addition, other configurations can be added to, removed from, or replaced with a part of the configuration of each embodiment.

What is claimed is:

1. A distance measurement device that measures a distance to an object based on a time of flight taken until irradiation light is reflected by the object and returns to the distance measurement device, the device comprising:
a light-receiving unit that exposes an image sensor to reflected light reflected by the object, to convert the reflected light into an electric signal;
an exposure control unit that controls an exposure gate for the reflected light in the light-receiving unit;
a brightness measurement unit that measures an exposed electric charge amount of the light-receiving unit as a brightness; and
a control unit that controls the exposure control unit and the brightness measurement unit,
wherein the exposure control unit includes an exposure gate cycle control unit that controls a cycle of the exposure gate, an exposure gate duty control unit that controls a duty of the exposure gate, and an exposure gate shift control unit that controls a shift amount of the exposure gate,
the control unit causes the brightness measurement unit to measure the exposed electric charge amount as a brightness while causing the exposure gate shift control unit to change the shift amount of the exposure gate, and sets a light emission and exposure timing of another distance measurement device to a shift amount of the exposure gate where the brightness is maximized,
the control unit causes the brightness measurement unit to calculate a variation in the brightness of the exposed electric charge amount while causing the exposure gate cycle control unit to change the cycle of the exposure gate, and determines that a value of the cycle of the exposure gate is a light emission period of the another distance measurement device, depending on whether or not there is a variation, and
the control unit causes the brightness measurement unit to calculate a variation in the brightness of the exposed electric charge amount while causing the exposure gate cycle control unit to change the cycle of the exposure gate, and determines that ½ of a value of the cycle of the exposure gate when the variation is minimized is a light emission cycle of the another distance measurement device.

2. The distance measurement device according to claim 1,
wherein it is known that the light emission period of the another distance measurement device is one of a plurality of predetermined values, and
the control unit calculates a variation in the brightness while setting the cycle of the exposure gate to the same value as each of the plurality of predetermined values in order from a smallest value, and determines that a set value of the cycle of the exposure gate immediately before when there is determined to be a variation is the light emission period of the another distance measurement device.

3. The distance measurement device according to claim 2,
wherein even when the cycle of the exposure gate is set to the same value as each of the plurality of predetermined values in order from the smallest value, in a case where it is not determinable that there is a variation, the control unit determines that a final set value of the cycle of the exposure gate is the light emission period of the another distance measurement device.

4. The distance measurement device according to claim 1,
wherein it is known that the light emission cycle for the light emission period of the another distance measurement device is one of a plurality of predetermined values, and
the control unit calculates a variation in the brightness while setting the cycle of the exposure gate to a value twice each of the plurality of predetermined values, and determines that ½ of the value of the cycle of the exposure gate when the variation is minimized is the light emission cycle of the another distance measurement device.

5. A distance measurement device that measures a distance to an object based on a time of flight taken until irradiation light is reflected by the object and returns to the distance measurement device, the device comprising:
a light-receiving unit that exposes an image sensor to reflected light reflected by the object, to convert the reflected light into an electric signal;
an exposure control unit that controls an exposure gate for the reflected light in the light-receiving unit;
a brightness measurement unit that measures an exposed electric charge amount of the light-receiving unit as a brightness; and
a control unit that controls the exposure control unit and the brightness measurement unit,
wherein the exposure control unit includes an exposure gate cycle control unit that controls a cycle of the exposure gate, an exposure gate duty control unit that controls a duty of the exposure gate, and an exposure gate shift control unit that controls a shift amount of the exposure gate, and
the control unit causes the brightness measurement unit to calculate a variation in the brightness of the exposed electric charge amount while causing the exposure gate cycle control unit to change the cycle of the exposure gate, and determines a light emission and exposure timing, a light emission period, and a light emission cycle of another distance measurement device based on a value of the variation.

6. The distance measurement device according to claim 5,
wherein the control unit detects a maximum value and a minimum value of the variation calculated while changing the cycle of the exposure gate, calculates a first threshold value from the maximum value and the minimum value that are detected, detects cycles of the exposure gate in which the variation is the first threshold value or less, calculates an interval between the detected cycles of the exposure gate, detects a maximum value of the calculated interval, calculates a second threshold value from the detected maximum value, sets the light emission period of the another distance measurement device to a maximum value of the cycle of the exposure gate in which the interval of the cycles of the exposure gate is the second threshold value or less and which corresponds to a variation equal to or less than the first threshold value, and sets the light emission cycle of the another distance measurement device to ½ of a minimum value of the cycle of the exposure gate in which the interval of the cycles of the exposure gate is the second threshold value or more and which corresponds to the variation equal to or less than the first threshold value.

7. A control method of a distance measurement device that measures a distance to an object by periodically repeating emission of irradiation light and exposure to reflected light from the object and by calculating a time delay of the reflected light with respect to the irradiation light from an amount of exposure accumulated in a predetermined exposure period, the method comprising:
measuring the amount of exposure as a brightness while changing a shift amount of an exposure gate for the reflected light, and setting a light emission and exposure timing of another distance measurement device to a shift amount of the exposure gate where the brightness is maximized;
calculating a variation in the brightness of the amount of exposure while changing a cycle of the exposure gate, and determining that a value of the cycle of the exposure gate is a light emission period of the another distance measurement device, depending on whether or not there is a variation; and
calculating a variation in the brightness of the amount of exposure while changing the cycle of the exposure gate, and determining that ½ of a value of the cycle of the exposure gate when the variation is minimized is a light emission cycle of the another distance measurement device.

8. The control method according to claim 7,
wherein it is known that the light emission period of the another distance measurement device is one of a plurality of predetermined values, and
a variation in the brightness is calculated while setting the cycle of the exposure gate to the same value as each of the plurality of predetermined values in order from a smallest value, and it is determined that a set value of the cycle of the exposure gate immediately before when there is determined to be a variation is the light emission period of the another distance measurement device.

9. The control method according to claim 8,
wherein even when the cycle of the exposure gate is set to the same value as each of the plurality of predetermined values in order from the smallest value, in a case where it is not determinable that there is a variation, it is determined that a final set value of the cycle of the exposure gate is the light emission period of the another distance measurement device.

10. The control method according to claim 7,
wherein it is known that the light emission cycle for the light emission period of the another distance measurement device is one of a plurality of predetermined values, and
a variation in the brightness is calculated while setting the cycle of the exposure gate to a value twice each of the plurality of predetermined values, and it is determined that ½ of the value of the cycle of the exposure gate when the variation is minimized is the light emission cycle of the another distance measurement device.

11. A control method of a distance measurement device that measures a distance to an object by periodically repeating emission of irradiation light and exposure to reflected light from the object and by calculating a time delay of the reflected light with respect to the irradiation light from an amount of exposure accumulated in a predetermined exposure period, the method comprising:
calculating a variation in a brightness of the amount of exposure while changing a shift amount of an exposure gate for the reflected light, and determining a light emission and exposure timing, a light emission period, and a light emission cycle of another distance measurement device based on a value of the variation.

12. The control method according to claim 11,
wherein a maximum value and a minimum value of the variation calculated while changing the cycle of the exposure gate are detected, a first threshold value is calculated from the maximum value and the minimum value that are detected, cycles of the exposure gate in which the variation is the first threshold value or less are detected, an interval between the detected cycles of the exposure gate is calculated, a maximum value of the calculated interval is detected, a second threshold value is detected from the detected maximum value, the light emission period of the another distance measurement device is set to a maximum value of the cycle of the exposure gate in which the interval of the cycles of the exposure gate is the second threshold value or less and which corresponds to a variation equal to or less than the first threshold value, and the light emission cycle of the another distance measurement device is set to ½ of a minimum value of the cycle of the exposure gate in which the interval of the cycles of the exposure gate is the second threshold value or more and which corresponds to the variation equal to or less than the first threshold value.
